(19) United States
(12) Patent Application Publication
(10) Pub. No.: US 2004/0223761 A1
(43) Pub. Date: Nov. 11, 2004

(54) Bidirectional transmitting and receiving device

(76) Inventor: Jorg-Reinhardt Kropp, Berlin (DE)

Correspondence Address: ESCHWEILER & ASSOCIATES, LLC, NATIONAL CITY BANK BUILDING, 629 EUCLID AVE., SUITE 1210, CLEVELAND, OH, 44114, US

(21) Appl. No.: 10/797,814

(22) Filed: Mar. 10, 2004

(30) Foreign Application Priority Data
Mar. 10, 2003 (DE) 103 11 571.4-35

(51) Int. Cl. H04B 10/24

(52) U.S. Cl. 398/41

(57) ABSTRACT

The invention relates to a bidirectional transmitting and receiving device having a transmitting component having an emission area of a first size, that emits light at a first wavelength, and a receiving component having a receiving area of a second size, that receives light at a second wavelength. The device further includes coupling optics for coupling a light between the transmitting component and the receiving component on the one hand and an optical waveguide that is to be coupled thereto on the other hand. According to the invention, the coupling optics have a diffraction structure that focuses light at the first wavelength and at the second wavelength differently, and the transmitting component and the receiving component are arranged alongside one another or one above the other, with transmitting component being located at the focus of the diffraction structure for the emitted wavelength, and light which is emitted from the transmitting component at the first wavelength being imaged on the end surface of the optical waveguide.

### REFERENCE TO RELATED APPLICATIONS

This application claims the benefit of the priority date of German Application 103 11 571.4-35, filed on Mar. 10, 2003, and is related to U.S. application Ser. No. ______, filed on Mar, 10, 2004 (Attorney Docket No. MAIKP125US) the contents of which are herein incorporated by reference in their entirety.

### FIELD OF THE INVENTION

The invention relates to a bidirectional transmitting and receiving device.

### BACKGROUND OF THE INVENTION

Bidirectional optical modules are known which communicate with one another using a monomode glass fiber in the opposite direction. The modules comprise a transmitting component, a receiving component and an optical arrangement, by means of which the beam paths are superimposed and split. The light which is emitted from the transmitting component generally, but not necessarily, is at a different wavelength than the light which is detected via the receiving component. For example, the transmitting component emits light at a wavelength of 1300 nm, and the receiving component detects light at a wavelength of 1550 nm.

A module of the cited type is known from WO 99/57594 A1. A partially reflective mirror which acts on a wavelength-selective basis is provided in order to split the beam paths, is arranged at an angle of 45° in the beam path of the fiber, and outputs light at a wavelength at an angle of less than 90°. If operated at the same wavelength, instead of with a mirror which acts on a wavelength-selective basis, a partially reflective mirror is used. The known bidirectional module disadvantageously requires relatively complex optical and mechanical design technology.

The use of polymer fibers with a diameter of 1 mm for bidirectional communication at the same wavelength is known from the automotive field. Bidirectional modules with a relatively large receiving diode are used in this case. An LED chip is fitted to the center of the receiving diode. The photodiode is admittedly partially shadowed by the LED chip, but the sensitivity of the transmission quality is sufficient for automotive applications. A corresponding design is described in DE 100 64 599 A1.

### SUMMARY OF THE INVENTION

The present invention is based on the object of providing a bidirectional transmitting and receiving device, which is distinguished by simple and compact design and, for this purpose does not need to use interference filters and a bent beam path. In contrast to the situation with the solutions that are known from the automotive field, a further aid is also to allow the use of relatively small photodiodes.

According to the invention, this object is achieved by a bidirectional transmitting and receiving device.

The solution according to the invention is accordingly distinguished in that the coupling optics have a diffraction structure which focuses light at the first wavelength and at the second wavelength differently. The transmitting component and the receiving component are arranged alongside one another or one above the other. The transmitting component is located at the focus of the diffraction structure for the emitted wavelength, such that light which is emitted from the transmitting component is imaged at the first wavelength on the end surface of the optical waveguide.

The solution according to the invention is based on the idea of using a diffraction structure for the coupling optics rather than the light-refracting structure that is normally used in the prior art. A diffraction structure causes light forming by means of interference effects. The light diffraction and focusing of the diffracted light are, of course, in this case highly dependent on the wavelength. The solution according to the invention provides for the transmitting component to be located at the focus of the diffraction structure for the emitted wavelength. The focus of the diffraction structure for the light at the received wavelength is located above, underneath or alongside the focus of the light for the emitted wavelength. This makes it possible to arrange the receiving component alongside or on the transmitting component. Overall, this results in an arrangement which does not require a bent beam path or separate interference filters for separation of the individual beam paths, and which is very compact since the transmitting component and the receiving component are arranged alongside one another or one above the other.

In one preferred refinement of the invention, the diffraction structure has a diffractive lens. The transmitting component is located at the focus of the diffractive lens for the emitted wavelength. In contrast, the receiving component is located away from the focus of the diffractive lens for the wavelength of the received light, so that light which is emitted from the optical waveguide at the second wavelength is detected by the receiving component in a further widened area (behind the focus) or in an area which has not yet been focused (in front of the focus). The transmitting component and the receiving component in this refinement are preferably arranged one behind the other in the beam path.

For the purposes of the invention, a diffractive lens is any lens which achieves light forming by diffraction or interference effects. In particular, one diffractive lens is a so-called Fresnel lens, also referred to as a “Fresnel zone plate”. A Fresnel lens has a large number of circular rings, whose separation decreases as the radius increases. Fresnel lenses are known to those skilled in the art and are described, for example, in Optical Engineering, Vol. 33, February 1994, No. 2, pages 647-652: “Diffractive Microlenses with Antireflection Coatings fabricated by Thin Film Deposition”.

Diffractive lenses for the purposes of the present invention also include holographic lenses. To be precise, holographic lenses are from this case also Fresnel lenses, since the latter represent a hologram on the point source.

The transmitting component and the receiving component are preferably arranged one behind the other in the beam path such that the light which is emitted from the transmitting component passes through the receiving component. The receiving area of the receiving component is in this case preferably considerably larger than the imaging area of the transmitting component, in particular by a factor of at least 3. The use of a comparatively small imaging area ensures that that portion of the receiving component which cannot be used for light detection is as small as possible and, in a corresponding manner, that the sensitivity of the receiving component is influenced only to a minor extent. Since the receiving component detects the light to be detected in a region which is not focused, the detection area may also be relatively large. The region which cannot be used and through which light from the transmitting element passes is then negligible.

The combination of a transmitting component with a small imaging area and a receiving component with a large receiving area is thus preferably positioned at the focal point for the wavelength of the light which is emitted from the transmitting component. If the transmitting component in this case has a shorter wavelength (for example 850 nm) than the light which is received by the detector (for example 1300 nm), then the combination is located at the rear focal point. The light at the longer wavelength is focused to a certain extent by the diffraction structure and then diverges again, so that the receiving component detects the light to be detected in a region which has been widened again. The receiving component, which is likewise located virtually in the plane of the focus for the wavelength which is emitted from the transmitting component, in any case away from the focus for the wavelength of the light to be detected, is in this case, however, large enough in order to detect the already somewhat widened radiation from the optical waveguide completely, or virtually completely.

If the transmitting component emits the longer-wave radiation, then the combination of the transmitting component and receiving component is located on the front focal length plane. The radiation to be detected from the optical waveguide and which is at the shorter wavelength has not yet been focused in the plane in which the transmitting component and receiving component are located, and likewise falls onto a large area of the receiving component.

It should be mentioned that other arrangements are also within the scope of the present invention. For example, as an alternative, it is possible to provide for the transmitting component to be located in front of the receiving component. In this case, the transmitting component emits the longer-wave radiation and is located on the front focal length plane, which is located closer to the diffraction structure. The receiving component which detects the shorter-wavelength radiation is in contrast located behind the transmitting component. It may be located immediately behind the transmitting component, or else at the rear focus for the shorter wavelength. Since the light to be detected has not yet been focused on the front focal length plane, the proportion of the light to be detected which is blocked by the transmitting component is small, so that the sensitivity of the receiving component is scarcely reduced.

However, it is regarded as being preferable for the light which is emitted from the transmitting component to pass through the receiving component. Provided that the receiving component is not sensitive and is transparent for the wavelength that is emitted by the transmitting component, the radiation from the transmitting component passes through the receiving component without any further measures.

Provided that the substrate of the receiving component is transparent for the transmitter radiation, that the receiving area (the active region) of the receiving component absorbs this radiation and is sensitive to it, a region with a small diameter is preferably kept free in the receiving area of the receiving component, for the radiation from the transmitting component which is located underneath it to pass through.

If the substrate of the receiving component is not transparent for the radiation for the transmitting component, then a small opening is preferably formed in the receiving component, through which the light which is emitted from the transmitting component passes.

The receiving component is preferably mounted directly on the transmitting component, in particular by flip-chip mounting or adhesive bonding. As has been described above, the emissions from the transmitting component pass through the receiving component, with the emitted radiation being imaged directly on the end surface, and on a small input area of the optical waveguide there, because the transmitting component is located at the focus of the diffraction structure.

One preferred refinement of the present invention provides for the use of a relatively large-area receiving component with a small local transparent area, through which the light which is emitted from the transmitting component passes. The sensitivity of the receiving component is scarcely reduced because the receiving area is considerably larger than the emission area of the transmitting component. To do this, it is, of course, also necessary not only for the receiving component to have a larger receiving area, but for the light which is emitted from the end surface of the optical waveguide also to be imaged on a comparatively large area of the receiving surface. This is achieved by the receiving area (unlike the emission area of the transmitting component) not being located at the focus of the diffraction structure of the coupling optics for the wavelength under consideration, so that the receiving component detects the light which is emitted from the optical waveguide in a region which has been widened again, or has not yet been focused. At the same time, this ensures precise injection of the transmission light into the optical waveguide, since the transmitting component is located in the focus of the diffraction structure for the wavelength of the emitted light.

In a further preferred refinement to the present invention, the diffraction structure comprises an optical grating in conjunction with a refractive lens or lens arrangement, or an asymmetric diffractive lens. In this case, the emitted light and the received light are deflected at different angles. This allows the transmitting component and the receiving component to be arranged alongside one another and, in principle, the receiving component can also additionally be arranged offset in the vertical direction with respect to the transmitting component.

When using a diffraction structure comprising an optical grating in conjunction with a refractive lens, the optical grating deflects the light as a function of the wavelength, while the refractive lens provides light forming or light focusing. An optical grating is in this case a grating with equidistant gaps with a specific separation.

Light deflection at different angles is also achieved by an asymmetric diffractive lens, that is to say a diffractive lens in which the individual zones do not run concentrically around a center point. A diffractive lens such as this produces light deflection as well as focusing.

Since light at different wavelengths is deflected differently, it is possible to arrange the transmitting component and the receiving component alongside one another, with both the transmitting component for the wavelength of the emitted light and the receiving component for the wavelength of the received light being located at the focus of the diffraction structure. However, in order to enlarge the area of the receiving component which is illuminated by the received light, it may also be worthwhile arranging the receiving component in front of or behind the focus plane.

When using a diffraction structure which deflects the emitted and received light at different angles, the optical waveguide preferably has an end surface which is inclined with respect to the optical waveguide axis, such that the light to be detected is emitted from the end surface at an angle to the optical waveguide axis. In principle, angled emission may also be achieved in different ways in this case. The imaging system with the diffraction structure is arranged laterally offset with respect to the optical waveguide axis, so that the light falls obliquely on the diffraction structure and is then deflected at different angles as a function of the wavelength. As already explained, this makes it possible to arrange the transmitting component and the receiving component alongside one another.

The diffraction structure is preferably arranged in the beam path such that the light which is emitted from the transmitting component passes between the transmitting component and the diffraction structure essentially parallel to the optical waveguide axis. This makes it possible to use simple geometries, by means of which the emitted light is emitted vertically upwards, for example by means of a vertically emitting laser diode.

If the diffraction structure is formed by an optical grating in conjunction with a refraction lens or lens arrangement, a plano-convex lens is preferably provided, in which the optical grating is formed on the planar face. The optical grating may likewise be formed on a separate part, which is then arranged on the planar face of the plano-convex lens.

In one preferred refinement of the invention, a substrate is provided which has a first surface which faces an optical waveguide which is to be coupled, and a second surface, which is essentially parallel to the former. The diffraction structure is in this case formed or arranged on the first surface. The combination of the transmitting component and the receiving component is arranged on the second surface. This results in a compact arrangement of the individual elements of the device according to the invention. In developments, the combination of the transmitting component and receiving component is sheathed by a potting compound, in order to protect the components against external influences.

The compactness of the arrangement is further increased if the first surface of the substrate is connected to a guide element for coupling of an optical waveguide, so that an optical waveguide such as this can be coupled in a simple manner.

### BRIEF DESCRIPTION OF THE DRAWINGS

The invention will be explained in more detail in the following text using a number of exemplary embodiments and with reference to the figures of the drawing, in which:

FIG. 1 shows a schematic illustration of the basic configuration of a first exemplary embodiment of a bidirectional transmitting and receiving device;

FIG. 2 shows a first exemplary embodiment of the arrangement of a transmitting component and receiving component for the transmitting and receiving device as shown in FIG. 1;

FIG. 3 shows a second exemplary embodiment of the arrangement of a transmitting component and receiving component for the transmitting and receiving device as shown in FIG. 1;

FIG. 4 shows the arrangement as shown in FIG. 1, together with a leadframe and a guide element for coupling an optical waveguide;

FIG. 5 shows a schematic illustration of the basic configuration of a second exemplary embodiment of a bidirectional transmitting and receiving device;

FIG. 6 shows a specific exemplary embodiment of an arrangement as shown in FIG. 5;

FIG. 7 shows a central beam path through a Fresnel lens for wavelengths of 1300 nm and 1550 nm;

FIG. 8 shows the beam path through a Fresnel lens for wavelengths of 1300 nm and 1550 nm, with the object to be imaged being arranged a short radial distance away from the lens center;

FIG. 9 shows the beam path through a Fresnel lens for wavelengths of 1300 nm and 1550 nm, with the object to be imaged being arranged at a greater radial distance away from the lens center, and

FIG. 10 shows an exemplary embodiment of an asymmetric Fresnel lens.

### DETAILED DESCRIPTION OF THE INVENTION

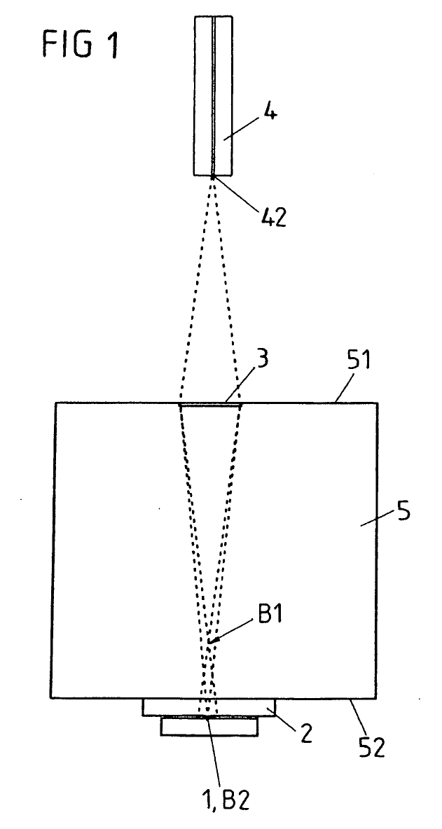

FIG. 1 shows a schematic illustration of the basic configuration of a bidirectional transmitting and receiving device, in which the transmitting component and the receiving component are arranged one behind the other in the beam path.

The device has a transmitting component 1, a receiving component 2, a diffractive lens 3 and an optical waveguide 4 arranged in a line, with the light which is emitted from the transmitting component 1 being coupled into the optical waveguide 4, and light which is received from the optical waveguide 4 being imaged on the receiving component 2, or on its receiving surface.

In the illustrated exemplary embodiment, the diffractive lens 3 is formed on one side 51 of a substrate 5 which has parallel side surfaces 51, 52. Alternatively, the diffractive lens 3 may also be formed on a separate mount, which is then attached to the first side surface 51. The transmitting component 1 and the receiving component 2 are arranged on the side surface 52 which is opposite the side surface 51 with the diffractive lens 3. This results in a particularly compact configuration. However, it should be mentioned that the arrangement of the diffractive lens 3, the transmitting component 1 and the receiving component 2 on a substrate mount 5 should be regarded only as an example and is in no way essential for the described configuration.

The diffractive lens 3 is a Fresnel lens which focuses the light emitted from the optical waveguide 4 and the light emitted from the transmitting component 1 by light diffraction rather than by light refraction. In the case of a diffractive lens, the focusing of the light is highly dependent on the wavelength, to a considerably greater extent than would be the case with a refractive lens.

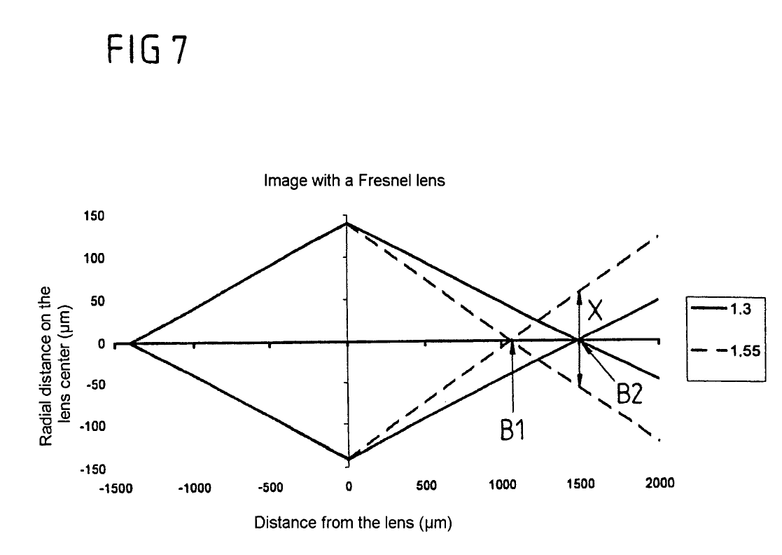

This means that the focal length of the Fresnel lens 3 is highly dependent on the wavelength of the radiation passing through it. This situation is illustrated in more detail for a number of exemplary embodiments in FIGS. 7 to 9.

First of all, reference should be made to FIG. 7. The distance from a Fresnel lens is indicated on the abscissa. The Fresnel lens is located at “zero”. The ordinate indicates the radial distance from the lens center. The figure shows the beam path for two wavelengths of 1300 nm (solid line) and 1550 nm (dashed line). The longer-wavelength light is focused to a greater extent, and has a shorter focal length B1. In contrast, the shorter wavelength light has a longer focal length B2.

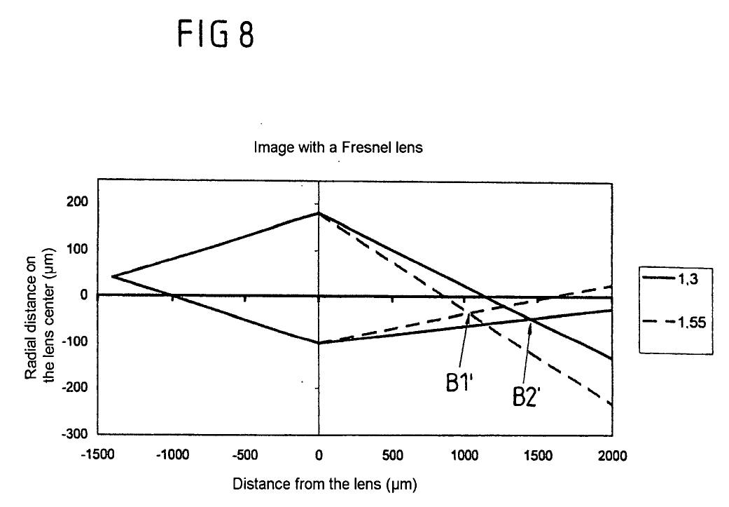

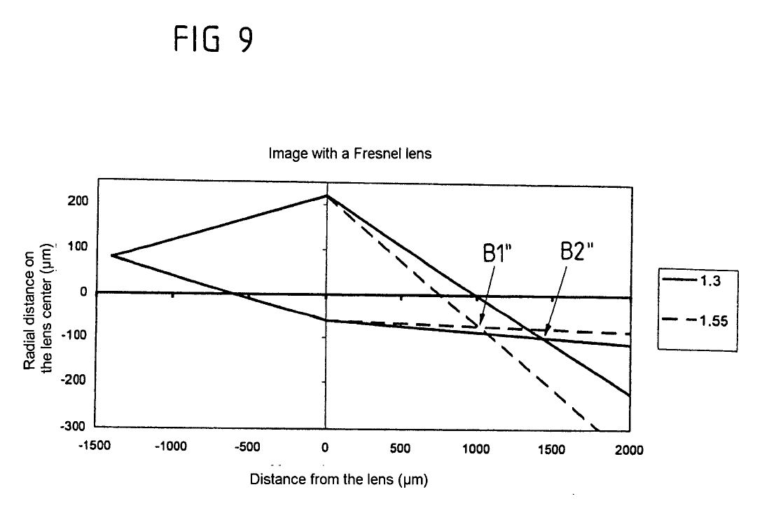

In FIG. 8, the point under consideration, from which radiation is emitted, is offset by about 30 μm with respect to the lens center. The two focal points B1′, B2′ for the two wavelengths are once again located at different distances from the lens. In addition, there is a slight radial offset. In FIG. 9, the point from the light waves are emitted is at a greater radial distance of about 80 μm from the lens center. Once again, the two focal points B1″ and B2″ are at different distances from the lens, and are additionally radially offset. The focus of the Fresnel lens is thus highly dependent on the wavelength of the light passing through it.

It should be mentioned that the relationships illustrated in FIGS. 7 to 9 are not schematic, but calculated.

As is shown in FIG. 1, the transmitting component 1 is now arranged with respect to the Fresnel lens 3 such that it is located at the focus B2 of the Fresnel lens 3 for the emitted wavelength. In a corresponding manner, light which is emitted from the Fresnel lens 3 is imaged directly on the end surface 42 of the optical waveguide 4.

In the exemplary embodiment shown in FIG. 1, the light which is emitted from the transmitting component 1 is at a shorter wavelength than the light which is detected by the receiving component 2. For example, the emitted light is at a wavelength of 850 nm, while the light which is received by the receiving component 2 is at a wavelength of 1300 nm. In a corresponding manner, the focus B1 for the received light is located in front of (above) the focus B2 for the shorter-wavelength light, at which, as explained, the transmitting component is arranged. Since the receiving component 2 is arranged essentially on the same plane as the transmitting component 1, this now means that the light which is detected by the receiving component 2 is detected in a region which is located behind the focus B1. The received light is accordingly somewhat widened again in this region. This widened region, which should be located within the receiving area of the receiving component 2, is identified by X in FIG. 7.

The invention now provides for the receiving component 2 to have a receiving area of sufficient size to detect all of the widened radiation of the received light. The widening in this case has the advantage that the region of the receiving component 2 through which the light which is emitted from underneath the receiving component 2 from the transmitting component 1 passes is small in comparison with the total area which detects light. The loss of sensitivity is thus small.

The different focal lengths for different wavelengths of the diffractive lens 3 are thus used in a skillful manner such that the transmitting component 1 is located at the focus B2 of the diffractive lens 3, such that the emitted light is injected precisely into the optical waveguide 4, while the receiving area of the receiving component 2 is located away from the focus B1 of the received light, and accordingly detects the somewhat widened beam area of the received light.

This refinement makes it possible, inter alia, to use the arrangement with small-diameter optical waveguides as well, in particular also with single-mode optical waveguides. Precise light injection is ensured in the same way as detection of the received light, essentially without any reduction in sensitivity. However, the arrangement may, of course, also be used with large-diameter optical waveguides, in particular so-called POF (plastic optical fibers) waveguides.

If the transmitting component 1 emits the longer-wavelength radiation, the combination of the transmitting component 1 and receiving component 2 is located at the front focal point B1. As can be seen, for example from FIG. 7, the shorter-wavelength radiation to be detected has not yet been focused in this region and accordingly once again falls onto a large receiving area of the receiving component.

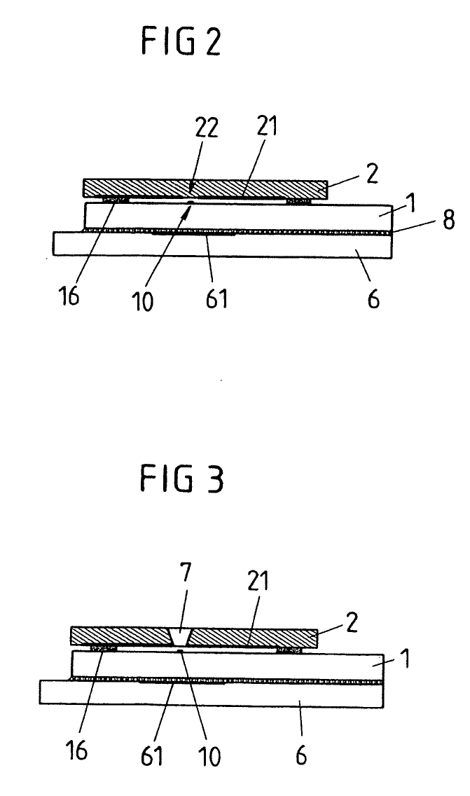

FIG. 2 shows one possible chip combination of a transmitting component 1 and receiving component 2 in greater detail. The transmitting component 1 is a vertically emitting laser diode with a light-emitting area 10, and contact is made with it in some suitable manner (not illustrated). It is also possible to use an edge-emitting laser diode with deflection optics. The receiving component 2 is a photodiode with a light-sensitive surface 21. The photodiode 2 is arranged directly on the transmitting component 1 by means of flip-chip contact 16 with solder (or alternatively via adhesive bonding). A monitor diode 6 with a light-sensitive surface 61 is located on the rear face of the laser diode 1. The laser diode 1 and the monitor diode 6 are connected to one another via an adhesive 8.

If both the substrate of the photodiode 2 and the light-sensitive surface 21 of the photodiode 2 are transparent for the light which is emitted from the laser 1, the light from the laser diode 1 can pass through the photodiode 2 without any further measures. If the substrate of the photodiode 2 is transparent for the radiation which is emitted from the transmitting element 1, but the active area 21 of the photodiode absorbs the emitted light and is sensitive to it, a small-diameter area 22 in the detector surface 21 is kept free, and is shown in FIG. 2, for the radiation for the laser diode 1, which is located underneath it, to pass through. This is achieved, for example, by selective removal of the active material, for example by etching, in this area 22. The exposed layers of the photodiode 2 must be passivated in a known manner after exposure, in order to guarantee ageing stability.

If the substrate of the photodiode 2 is not transparent for the radiation from the laser diode 1, then an opening must be formed in the photodiode 2 for the light to pass through. A corresponding opening 7 is illustrated in FIG. 3. The opening 7 is produced, for example, by selected etching of the rear face. This then results in a chip combination with a large-area flip-chip mounted detector 2 which has an optical opening 7 in the chip surface for the light from the transmitting component 1 to pass through.

FIGS. 2 and 3 show the area 22, 7 which is kept free or cut out to be relatively small in comparison with the light-sensitive area 21 of the detector 2. For example, the area 22, 7 which is kept free or cut out has a diameter of 40 μm while the receiving area of the photodiode 2 has a diameter of 200 μm, so that the area corresponds to 4%. In consequence, the deduction in the sensitivity of the photodiode 2 is only minor.

The use of a non-transparent substrate for the photodiode 2 as shown in FIG. 3 has the advantage that the photodiode 2 is influenced only slightly by stray light which can fall onto the light-sensitive surface 21 if the substrate is transparent.

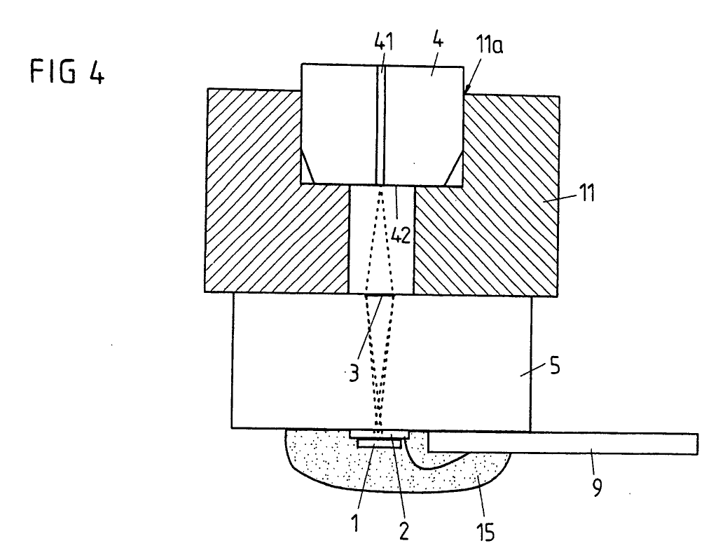

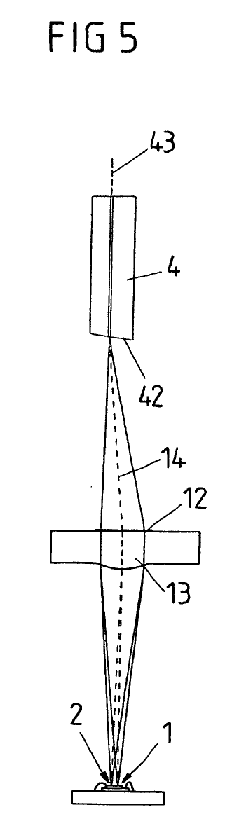

The device shown in FIG. 4 illustrates the arrangement as shown in FIG. 1 with further elements. A mount 9 for electrical supply lines, in particular a leadframe, is provided in order to make electrical contact with the transmitting component 1 and the receiving component 2. The transmitting component 1 and the receiving component 2 are also protected by a potting compound 15. A guide element 11 which has a holding opening 11a for coupling of an optical waveguide 4 is arranged on the upper face of the substrate 5. The optical waveguide 4 is, for example, a single-mode waveguide. The line is injected and output from the core area 41, through the end face 42 of the optical waveguide. The beam path corresponds to the beam path shown in FIG. 1.

The following should also be noted. The end surface 42 of the optical waveguide 4 is arranged at such a distance from the diffractive lens 3 that the light which is emitted from the end surface 42 is focused by the diffractive lens 3. The wavelength-dependent focal point is annotated as the focus B1, B2. The term focus is thus used to denote the locus or the distance from the lens 3 at which the light which is emitted from the optical waveguide 4 is focused, and at which the transmitting component 1 is located in order that its light is imaged on the optical waveguide 4. The focus is the locus of sharp imaging. The term focus therefore in no way just means the point or distance at which the parallel light is focused by a lens.

In an alternative refinement of FIGS. 1 and 4, the transmitting component 1 is located at the front focus B1. The transmitting component then emits the longer-wavelength light. The receiving component 2, which detects shorter-wavelength light, is located behind this, for example at the focus B2. Since the light to be detected has not yet been focused on the front focal length plane B1, the proportion of the light to be detected which is blocked by the transmitting component is small, so that the sensitivity of the receiving component is scarcely reduced. In order to prevent the light to be detected from falling on the transmitting component, a filter for the wavelength of the light to be detected can be arranged immediately in front of it.

In a corresponding manner, a selective filter layer can also be applied directly to the receiving component, filtering out the light of the transmitting component in order to reduce crosstalk. This applies to all the described exemplary embodiments.

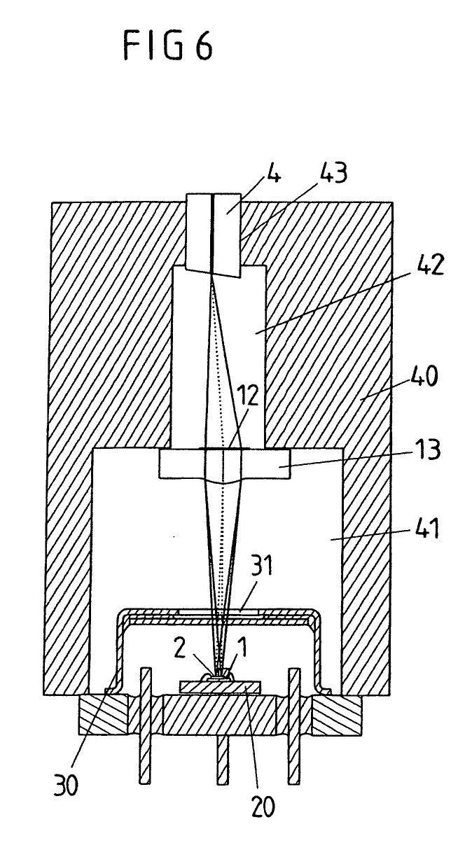

FIGS. 5 and 6 show an alternative exemplary embodiment of a bidirectional transmitting and receiving device.

The combination of an optical grating 12 and a refractive lens 13 is provided as coupling optics between an optical waveguide 4 on the one hand and a transmitting component 1 or a receiving component 2 on the other hand. The refractive lens 13 is in this case, for example, a plano-convex lens, on whose planar face the grating 12 is located. The grating 12 may, of course, also be formed on a separate part, and can then be applied to the lens.

The end surface 42 of the optical waveguide 4 is inclined to about 8° with respect to the normal to the waveguide axis 43. For optimum light output and input, the center point beam of the input or output light 14 is inclined to about 4° with respect to the longitudinal axis 43 of the optical waveguide 4.

The grating 12 now deflects the obliquely incident light to a different extent as a function of the wavelength. Finally, the refractive lens 13 focuses the light. Since light at different wavelengths is deflected at different angles in this refinement, the transmitting component 1, which is illustrated only schematically, and the receiving component 2 are arranged alongside one another. Both are located at the focus of the respective radiation. The transmitting component and the receiving component are preferably arranged closely alongside one another, particularly preferably on a common mount substrate, thus resulting in a particularly compact arrangement.

It should be mentioned that, although the refractive lens 13 provides different focal lengths for light at different wavelengths, the focal lengths at the various wavelengths are subject to only comparatively minor differences when a refractive lens is used (in contrast to the situation with a diffractive lens). The transmitting component 1 and the receiving component 2 can thus be arranged essentially alongside one another. Apart from this, the focal length of the refractive lens 13 can be chosen such that the foci are at different distances for the individual wavelengths. Other wavelength separation geometries can also be achieved by the use of different gratings.

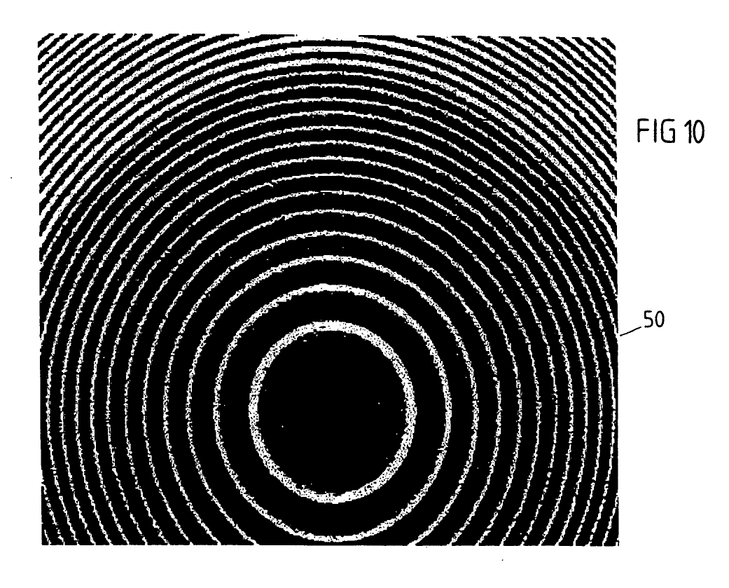

Instead of an optical grating 12 in conjunction with a refractive lens 13, it is also possible to use an asymmetric diffractive lens, which deflects the light as a function of the wavelength in addition to focusing it. One example of an asymmetric diffractive lens 50 such as this is illustrated schematically in FIG. 10. The asymmetric lens 50 corresponds to an eccentric section of a symmetrical Fresnel lens. This can also be seen with reference to FIG. 9. The lens in FIG. 10 corresponds to an upper area of the lens (arranged at “0”) shown in FIG. 9. The point from which light waves are emitted is arranged centrally for the lens area under consideration. The light is focused as a function of its wavelength at the axially offset points B1″ and B2″, which are also radially offset, that is to say the light is both focused and differently deflected by the lens.

FIG. 6 shows the complete coupling arrangement for the exemplary embodiment shown in FIG. 5. The combination of the transmitting component and receiving component 2 is arranged in a hermetically sealed pack 30 on a substrate 20. In the illustrated exemplary embodiment, this is a TO (Transistor Outline) pack with a light outlet window 31, which is known per se. However, any other desired pack may also in principle by used.

The pack 30 together with the transmitting component 1 and the receiving component 2 is arranged in the same way as the coupling optics 12, 13 and the optical waveguide 4 on a mount 40 which has three cylindrical areas 41, 42, 43 of different diameter. The pack 30 is fitted in the first area 41. The transition between the first area 41 and the second area 42 is used as a stop for the coupling optics 13. The third area 43 is used to hold an optical waveguide 4 which, for example, is in the form of a stub pin which has a plug at its end which is not shown, for connection to an optical fiber.

The arrangement shown in FIG. 6 should also be regarded only as an example. The combination of the transmitted component and receiving component may also, for example, be fitted directly to a circuit mount which may additionally contain the drive electronics for the transmitting components and/or a preamplifier for the receiving component. The mount 40 shown in FIG. 6 in a refinement such as this may then be connected directly to a circuit mount such as this, after suitable adjustment.

Furthermore, the refinement of the mount 40 should also be regarded only as an example. The coupling optics and a waveguide which is to be connected may also be positioned in some other suitable manner.

The embodiment of the invention is not restricted to the exemplary embodiments described above. The only essential feature for the invention is that light at different wavelengths is separated by means of a diffraction structure, with the transmitting component being located at a focus of this diffraction structure for the emitted wavelength.

1. A bidirectional transmitting and receiving device, comprising:
a transmitting component comprising an emission area of a first size, that emits light at a first wavelength;
a receiving component comprising a receiving area of a second size, that receives light at a second wavelength; and
coupling optics adapted to couple light between the transmitting component and the receiving component on one hand and an optical waveguide that is to be coupled on the other hand, wherein the coupling optics comprise a diffraction structure that focuses light at the first wavelength and at the second wavelength differently, and
wherein the transmitting component and the receiving component are arranged alongside one another or one above the other, and wherein the transmitting component is located at the focus of the diffraction structure for the emitted light at the first wavelength, and light that is emitted from the transmitting component at the first wavelength is imaged on an end surface of the optical waveguide.

2. The device as claimed in claim 1, wherein the diffraction structure comprises a diffractive lens, and wherein the transmitting component is located at the focus of the diffraction structure for the emitted light at the first wavelength, while the receiving component is located away from the focus of the diffraction structure for the received light at the second wavelength, and light which is emitted from the optical waveguide at the second wavelength is detected in an area that is widened again or is not yet focused.

3. The device as claimed in claim 2, wherein the transmitting component and the receiving component are arranged one behind the other in the beam path, with the receiving area of the receiving component being larger than the emission area of the transmitting element by a factor of at least three.

4. The device as claimed in claim 3, wherein the light that is emitted from the transmitting component at the first wavelength passes through the receiving component.

5. The device as claimed in claim 4, wherein the receiving component comprises a local transparent area in the region of the receiving area, through which the light that is emitted from the transmitting component passes.

6. The device as claimed in claim 2, wherein the receiving component is mounted directly on the transmitting component by flip-chip mounting or adhesive bonding.

7. The device as claimed in claim 1, wherein the diffraction structure comprises an optical grating in conjunction with a refractive lens or an asymmetric diffractive lens, with the emitted light and the received light being deflected at different angles.

8. The device as claimed in claim 7, wherein the transmitting component and the receiving component are arranged generally alongside one another.

9. The device as claimed in claim 7, wherein the transmitting component is located at the focus of the diffraction structure for the emitted light at the first wavelength, and the receiving component is located at the focus of the diffraction structure for the received light at the second wavelength.

10. The device as claimed in claim 7, wherein the optical waveguide comprises an end surface that is inclined with respect to the optical waveguide axis, and the refractive or diffractive lens is arranged laterally offset with respect to the optical waveguide axis.

11. The device as claimed in claim 10, wherein the diffraction structure is arranged in the beam path such that the light that is emitted from the transmitting component passes between the transmitting component and the diffraction structure generally parallel to the optical waveguide axis.

12. The device as claimed in claim 7, wherein, in the diffraction structure that is in the form of an optical grating in conjunction with a refractive lens, the optical grating is formed or arranged on a planar face of a plano-convex lens.

13. The device as claimed in claim 7, wherein non-centric rings with a different phase relationship are provided for the diffraction structure that is in the form of an asymmetric diffractive lens.

14. The device as claimed in claim 1, further comprising a substrate having a first surface that faces an optical waveguide that is to be coupled thereto, and having a second surface that is generally parallel to the former, wherein the diffraction structure is formed or arranged on the first surface, and wherein the combination of the transmitting component and receiving component is arranged on the second surface.

15. The device as claimed in claim 14, wherein the combination of the transmitting component and the receiving component is sheathed by a potting compound.

16. The device as claimed in claim 14, wherein the first surface of the substrate is connected to a guide element for connection of an optical waveguide.
